(19) United States
(12) Patent Application Publication
(10) Pub. No.: US 2025/0307230 A1
(43) Pub. Date: Oct. 2, 2025

(54) SYSTEM AND METHOD FOR ACCURATE VALIDATION AND PREDICTION OF CLASSIFICATION OF VEHICLES

(71) Applicants: Pedro Baiz, London (GB); Szymon Padlewski, London (GB); Danielle Walsh, London (GB)

(72) Inventors: Pedro Baiz, London (GB); Szymon Padlewski, London (GB); Danielle Walsh, London (GB)

(73) Assignee: TOGETHER GLOBAL LTD, London (GB)

(21) Appl. No.: 18/616,223

(22) Filed: Mar. 26, 2024

(51) Int. Cl. G06F 16/23; G06F 16/215; G06F 16/28; G07C 5/04

(52) U.S. Cl. CPC G06F 16/2365; G06F 16/215; G06F 16/285; G07C 5/04

(57) ABSTRACT

The present invention discloses a system and method for accurate validation and verification or prediction of official classification of vehicles. The system comprises a database comprising information related to classification of vehicles and a server in communication with the database comprising an artificial intelligence. The server is configured to receive vehicle data including at least one of a vehicle identification number (VIN) related data, a geospatial data, a trip data, an identification data and an operation data of the vehicle. The server is configured to detect issues in the vehicle data and a level of risk of each vehicle data, and generate a risk matrix. The server cleanses vehicle data based on the risk level associated with each vehicle data. The server determines an official classification of the vehicles and suggests correction of existing assignments of classification of vehicles if the existing assignments are incorrect.

### TECHNICAL FIELD

The present invention generally relates to classification of vehicles. More specifically, the present invention relates to a system and method for accurate validation and prediction of official classification of vehicles.

### BACKGROUND

A vehicle classification system involves the classification of vehicles into different groups based on features, for example, weight, number of axles, design, and purpose. The vehicle classification system is used by organizations and authorities to understand and manage the types of vehicles on the road. The classification of vehicles is used for official purposes, for example, for imposing access to RAZs (Regulated Access Zones) such as Low Emissions Zones (LEZ); imposing any type of road related regulation such as the use of tachographs; defining government benefits or grants such as Tax Credits, etc. The classification of vehicles creates a standardized framework for identifying and distinguishing various types of vehicles, which plays a crucial role in enforcing regulations, taxation, road safety, transport planning, traffic management, to promote environmentally friendly transportation, vehicle registration, etc. In summary, an official vehicle classification has important (e.g., regulatory, financial) implications for the use & operations, purchase, investment, decommissioning, or any other important aspects on the life of a vehicle.

Vehicle classification generally varies between countries and regions. The specific classification system in use in a given area will depend on local regulations and requirements. Attempts to automate Vehicle classification in the past have not proven particularly successful and/or economically justifiable, because of the wide variety of vehicle configurations and differences between national or regional jurisdictions.

Further few existing patent applications related to the problems cited in the background are explained as follows.

US20230069070 of Razvan RANCA et al. entitled “method of universal automated verification of vehicle damage” discloses a computer-implemented method of generating a damage classification for a vehicle. The method involves steps of receiving a plurality of images of the vehicle; determining, using one or more classifiers that are specific to a plurality of parts of the vehicle, at least one classification of damage to the vehicle based on at least the plurality of images, and outputting the determined classifications of the damage to the vehicle. Each classifier is generic with respect to a make and model of the vehicle.

US20210124353 of Bill Dally et al. entitled “combined prediction and path planning for autonomous objects using neural networks” discloses a computer-implemented method, comprising the steps of: sensing, using one or more sensors of a first object, one or more characteristics of one or more secondary objects; determining, using a processor of the first object, and based on the one or more characteristics and probable reactive actions of at least one second object, one or more possible navigation paths for the one or more secondary objects; and selecting a navigation path from the one or more possible navigation paths based, at least in part, on a value function corresponding to sensed characteristics of the one or more secondary objects. However, the Bill Dally and Razvan RANCA references only discuss utilizing artificial intelligence/machine learning in the field of vehicles but lack a solution for accurately classifying vehicles.

U.S. Pat. No. 10,345,449 of Samuele Salti et al. entitled “Vehicle classification using a recurrent neural network (RNN)” discloses a device to receive GPS data or values for a set of metrics at a set of GPS points that form a GPS track of a vehicle. The device is configured to determine additional values for additional metrics using the GPS data or the values for the set of metrics. The device is further configured to determine a set of vectors for the set of GPS points using the GPS data, the values, or the additional values. The set of vectors are used in a recurrent neural network (RNN) to classify the vehicle. The device is configured to process the set of vectors via one or more sets of RNN layers of the RNN. The device could determine a classification of the vehicle using a result of processing the set of vectors and perform an action based on the classification of the vehicle. However, Samuele reference relies only on GPS/Telematics data for classification, potentially leading to no outputs when GPS/Telematics data is not available and/or leading to results that may not be deemed ‘official.’ Furthermore, the Samuele reference is exclusively based on Recurrent Neural Networks (RNNs).

WO2022189004 of Antonio Albanese et al. entitled “method and system for classifying vehicles by means of a data processing system” discloses a method for classifying vehicles by means of a data processing system, particularly for classifying vehicles according to the nature of their vehicle drivers, comprising the following steps: collecting driving data regarding vehicles driving in a predefined local area within a predefined time window; learning a driving policy of one or more vehicles in said local area from said driving data; generating or using a local predictor indicating a prediction of a definable driver behavior over a definable time horizon; sharing the local predictor with other vehicles in said local area to provide at least one combined predictor; redistributing at least one combined predictor back to vehicles in said local area; and locally classifying at least one of said vehicles based on at least one combined predictor and/or the local predictor into a definable vehicle class for providing at least one local classification. However, the Antonio reference focused on differentiating between human driven and Autonomous Vehicles. Moreover, the Antonio reference lacks to cover our wide range of data input for multi modal ML.

US20190311289 of Linh Vuong Nguyen entitled “Vehicle classification based on telematics data” discloses a method for vehicle classification comprising steps of acquiring motion data from a device in a vehicle during a trip, and applying the motion data to a trained classifier to produce a commercial classification of the vehicle. However, Linh reference only focuses on motion/vibration data and lack to covers a much wider range of data inputs (multi modal ML).

U.S. Pat. No. 11,233,650 of Antonino Mondello et al. entitled “Verifying identity of a vehicle entering a trust zone” discloses a method involving steps of: receiving, from a vehicle approaching a trust zone, an identifier corresponding to an identity of the vehicle; verifying, by a computing device (e.g., an access server at a gate of the trust zone) and using the identifier, the identity of the vehicle; and comparing the identity of the vehicle with a set of authorized identities stored in a database. However, the Antonino reference also lacks to cover a wider range of data inputs (multi modal ML).

CN112435463 of Ye Zhoujing et al. entitled “Vehicle type and vehicle weight classification method based on road internet of things monitoring” discloses a vehicle type and vehicle weight classification method based on road internet of things monitoring, and belongs to the field of road monitoring. The method comprises the following steps: acquiring a training set; establishing a vehicle type classification model based on an artificial neural network, training and verifying the vehicle type classification model by using a training set, and classifying vehicles with unknown vehicle type information by using the trained vehicle type classification model; aiming at vehicles of the same model, establishing a vehicle weight classification model based on an artificial neural network, training and verifying the vehicle weight classification model by using a training set, and carrying out vehicle weight grading on the vehicles with unknown vehicle weight information by using the trained vehicle weight classification model; and aiming at the vehicles of the same vehicle type, performing cluster analysis on the training set to determine the vehicle with abnormal vehicle weight in the same vehicle type, and performing sampling inspection and weighing on the vehicle after the vehicle enters the gate. However, the Ye Zhoujing reference also lacks to cover a wider range of data inputs (multi modal ML).

U.S. Pat. No. 10,810,871 of Randal Henry Visintainer entitled “Vehicle classification system” discloses vehicle comprising at least one label describing handling characteristics of the vehicle for the benefit of autonomous vehicles in proximity to the vehicle. The labels may be non-visible, such as through use of UV or IR inks. The labels may be present such that they are visible regardless of view direction and may be affixed using a vehicle wrap applied to panels of the vehicle. Autonomous vehicles detect the labels and retrieve handling characteristics from a local database or a remote server. The autonomous vehicles are therefore relieved from the processing required to predict or infer the handling characteristics of the vehicle. However, the Randal Henry Visintainer reference focuses on autonomous vehicles.

Therefore, there is a need for a system and method for accurate validation and prediction of official classification of vehicles, specially using multi modal machine learning techniques.

### SUMMARY

The present invention discloses a system and method for accurate validation and prediction of official classification of vehicles. The system comprises at least one server and at least one database in communication with the server. The database comprises information related to official classification of vehicles. The server comprises one or more processors and at least one memory storing a set of program modules executable by the processor. The server comprises an artificial intelligence engine that possesses a range of machine learning models (e.g. RNN, CNN), including multi-modal ML.

The modules comprise an input module, a risk analysis module, a data cleansing module and an output module. The input module is configured to receive vehicle data. The vehicle data includes at least one of a vehicle identification number (VIN) related data, a geospatial data, a trip data, an identification data and an operation data of the vehicle. The input module is configured to receive vehicle data from any data sources/modes (e.g. image/video, audio, vibration, text, geospatial). The data cleansing module is configured to cleanse vehicle data type based on a level of risk associated with each vehicle data type. The risk analysis module is configured to detect one or more issues in the vehicle data type and generate a risk matrix. The risk analysis module is further configured to determine a level of risk of each vehicle data type.

The output module is configured to determine an official classification of the vehicles and suggest correction of existing assignments of classification of vehicles if the existing assignments are incorrect. The module further comprises a VIN decoding module, a VIN validation module and a VIN correction module if VIN information is available. The VIN decoding module is configured to decode vehicle identification number (VIN) related data. The VIN validation module is configured to validate the VIN related data. The VIN correction module is configured to suggest modification of the VIN related data when determining errors in the VIN related data. The server is further configured to determine emission values of the vehicle using vehicle data and classification of vehicle.

The vehicle data type further includes video and image data, audio and vibration data, regulatory and compliance data, operations and logistics data, energy data, financial data, telematics and mobility data, data from vehicle repositories and text data. The vehicle data type further includes region, weight, purpose and size of vehicle. The trip data of the vehicle can include average speed, jerk, vibration, sound, driver's behavior, acceleration, start location of the vehicle and stop location of the vehicle. The identification data of the vehicle may include model, registration year, engine model, manufacturer and plate number. The operation data of the vehicle may include cargo type, average daily distance, number of stops, cargo weight, number of trips, consignor, consignee, volume and time including estimated, expected time of arrival (ETA) and actual ETA. The geospatial data of the vehicle includes bounding box size, point of interest (POI), surrounding dwellings, surrounding POIs, surrounding vehicles and prediction confidence. The regulatory and compliance data includes information related to tyres, regulated access zones, energy use and emission reporting of vehicles, whereas the data from vehicle repositories includes national & official vehicle classification, international vehicle classification and original equipment manufacturer (OEM) vehicle information.

The server is configured to receive video data and image data of the vehicle. The system further comprises one or more sensors in communication with the server. The server is agnostic to the specific sensors and such sensors could be configured to receive and send audio data and vibration data related to the vehicle to the server. Audio and vibration data could originate from the vehicle itself or any other audio or vibration sensor linked or related to the vehicle, including for example smart phones, telematics devices, nearby smart devices (smart cities), etc. Further, the sensor comprises OEM sensors, smart phone sensors, third party sensors, audio and vibration sensors and telematics sensors.

In one embodiment, a method for accurate validation and prediction of official classification of vehicles is disclosed. The method is executed at the system comprising at least one database comprising information related to official classification of vehicles, and at least one server in communication with the database. The server comprises one or more processors and at least one memory storing a set of program modules executable by the processor. The server is configured to receive video data and image data of the vehicle or surrounding devices. The system further comprises one or more sensors in communication with the server (server is agnostic to the specific sensors). The sensors can be configured to collect audio, vibration and other multi-modal data of the vehicles or its surroundings (e.g. geospatial, satellite).

At one step, the input module at the server is configured to receive vehicle data. The vehicle data includes at least one of a vehicle identification number (VIN), a trip or a route data, an identification data or an operation data of the vehicle. The input module is configured to receive vehicle data from any data sources/modes (server is agonistic to sensor types and brands/models). At another step, the data cleansing module at the server is configured to cleanse vehicle data based on the level of risk associated with each vehicle data.

At yet another step, the risk analysis module at the server is configured to detect one or more issues in the vehicle data and generate a risk matrix. The risk analysis module is further configured to determine a level of risk of each vehicle data type.

At yet another step, the output module at the server is configured to determine an official classification of the vehicles and suggest correction of existing assignments of classification of vehicles if the existing assignments are incorrect.

At yet another step, if the vehicle data comprises vehicle identification number (VIN) related data, the VIN decoding module at the server is configured to decode vehicle identification number (VIN) related data. At yet another step, the VIN validation module at the server is configured to validate the VIN related data. At yet another step, the VIN correction module at the server is configured to suggest modification of the VIN related data when determining errors in the VIN related data. The server is further configured to determine default emission values of the vehicle using vehicle data and classification of vehicle. The system is able to perform all these data validation and verification steps mainly when there is availability of many different and independent datasets that facilitate such a process.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of a system for accurate validation and prediction of official classification of vehicles, according to an embodiment of the present invention.

FIG. 2 exemplarily illustrates a block diagram of the server, according to an embodiment of the present invention.

FIG. 3 is a block diagram of different types of vehicle data collected by the system for classification of vehicles, according to an embodiment of the present invention.

FIG. 4 exemplarily illustrates a flowchart of a method for accurate validation and prediction of official classification of vehicles, according to an embodiment of the present invention.

FIG. 5 exemplarily illustrates a table for assessing different levels of risk of vehicle data, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

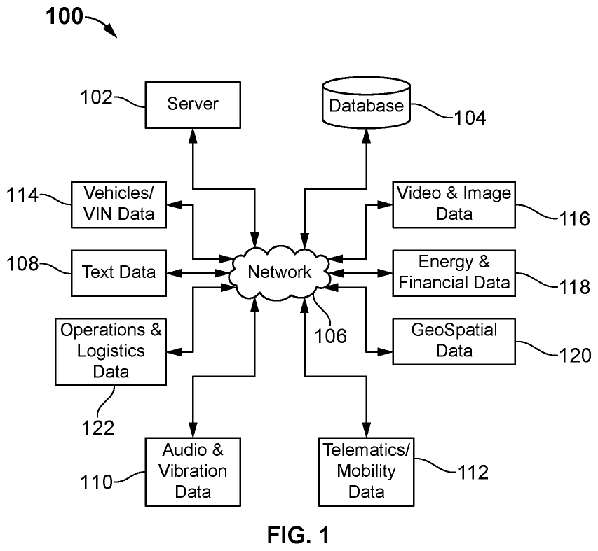

FIG. 1 exemplarily illustrates an environment 100 of a system for accurate validation and prediction of official classification of vehicles, according to an embodiment of the present invention. The classification of vehicles refers to a vehicle classification used for official purposes, for example, for imposing access to regulated access zones (RAZs) such as low emissions zones (LEZ); imposing any type of road related regulation such as the use of tachographs; defining government benefits or grants such as tax credits; etc. In summary, an official vehicle classification has important (e.g., regulatory, financial) implications for the use & operations, purchase, investment, decommissioning, or any other important aspects on the life of a vehicle. The environment 100 of the system comprises at least one server 102 and at least one database 104 in communication with the server 102 via a network 106. The system further comprises one or more sensors including audio and vibration sensors, telematics sensor. The sensors are in communication with the server 102. The sensors are configured to receive acoustic data and vibration data of the vehicles. The server 102 is configured to receive video data and image data 116, energy and financial data 118, geospatial data 120, telematics/mobility data 112, audio and vibration data 110, operations and logistics data 122, text data 108, and vehicles/VIN data 114.

The server 102 could be any suitable server(s) for storing information, data, programs, and/or any other suitable content. In an example, the server 102 is at least one of a general or special purpose computer. The server 102 operates as a single computer, which could be a hardware and/or software server, a workstation, a desktop, a laptop, a tablet, a mobile phone, a mainframe, a supercomputer, a server farm, and so forth. Although the server 102 is illustrated as a single device, the functions performed by server 102 could be performed using any suitable number of computing devices.

The network 106 generally represents one or more interconnected networks, over which the sensors, the server 102 and database 104 could communicate with each other. The network 106 may include packet-based wide area networks (such as the Internet), local area networks (LAN), private networks, wireless networks, satellite networks, cellular networks, paging networks, and the like. A person skilled in the art will recognize that the network 106 may also be a combination of more than one type of network. For example, the network 106 may be a combination of a LAN and the Internet. In addition, the network 106 may be implemented as a wired network or a wireless network or a combination thereof.

The database 104 is accessible by the server 102. In an example, the database 104 resides in the server 102. In another example, the database 104 resides separately from the server 102. Regardless of location, the database 104 comprises a memory to store and organize data for use by the server 102. The database 104 stores all the information related to the classification of vehicles.

The server 102 is configured to receive vehicle data. The system or server 102 is configured to receive vehicle data from any data sources and modes. In one embodiment, the server 102 is configured to receive vehicle data from internal and external databases. In one embodiment, external database comprises official public data repositories provided by official/governmental organizations such as the national highway traffic safety administration (NHTSA) in the USA or the data exchange (DATEX II) in the EU. Further, external data also include commercial data repositories that include vehicle brand, models, costs, operations and other relevant data for classification of vehicles. In one embodiment, an internal database comprises internal datasets including proprietary data that helps fill the gap in external data such as equivalence mappings between different official classifications systems (e.g. NHTSA, DATEX II) and many other aspects related to this invention.

In one embodiment, the server 102 is configured to receive vehicle data from the sensors. In one embodiment, the vehicle data includes at least one of video data and image data 116, energy and financial data 118, geospatial data 120, telematics/mobility data 112, audio and vibration data 110, operations and logistics data 122, text data 108, and vehicles/VIN data 114. The vehicle data further includes trip data, identification data and operation data of the vehicle. The vehicle data can further include region, weight, purpose and size of vehicle.

The server 102 is configured to detect one or more issues in the vehicle data and generate a risk matrix. The server 102 is further configured to cleanse vehicle data based on a level of risk associated with each vehicle data. The server 102 is configured to determine the official classification of the vehicle as defined by its local jurisdiction and regulations. Further, the server 102 is configured to suggest correction of existing assignments of classification of vehicles if the existing assignments are incorrect. The server 102 is further configured to determine default emission values of vehicles. For example, the server 102 could use programs (Typically defined by governments, example is smart way program in USA), AI/ML or other simulation techniques or other default data approach along with the classification of vehicles to determine the emission value. The emission value could be used in, for example, TAX credit benefits, regulated access zones (RAZ) compliance, etc.

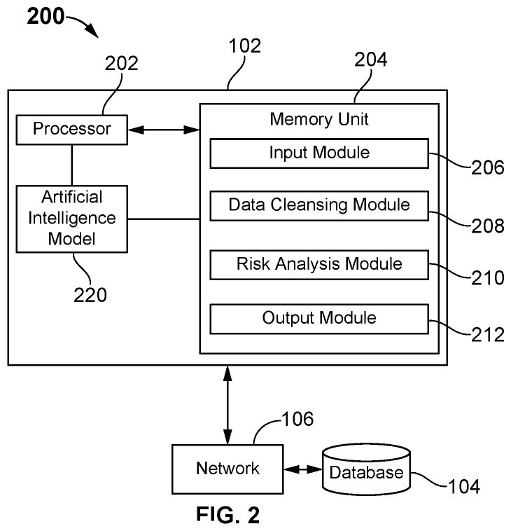

FIG. 2 exemplarily illustrates a block diagram 200 of the server 102, according to an embodiment of the present invention. The server 102 comprises at least one processor 202 and at least one memory 204. The memory 204 stores a set of program modules. The modules include an input module 206, a data cleansing module 208, a risk analysis module 210 and an output module 212. The server 102 comprises one or more artificial intelligence models 220.

The input module 206 is configured to receive vehicle data. The input module 206 is configured to receive vehicle data from any data sources/modes. The vehicle data may include at least one of a vehicle identification number (VIN) related data 114, a geospatial data 120, a trip data, an identification data and an operation data of vehicle. The vehicle data further includes a video and image data 116, an audio and vibration data 110, a regulatory and compliance data 422, an operations and logistics data 122, an energy and financial data 118, a telematics and mobility data 112, data from vehicle repositories and text data 108. The vehicle data further includes region, weight, purpose and size of vehicle. The trip data of the vehicle includes, but not limited to, average speed, jerk, vibration, sound, driver's behavior, acceleration, start location of the vehicle and stop location of the vehicle. The identification data of the vehicle includes, but not limited to, model, registration year, engine model, manufacturer and plate number. The operation data of the vehicle includes, but not limited to, cargo type, average daily distance, number of stops, cargo weight, number of trips, consignor, consignee, volume and time including estimated, expected time of arrival (ETA) and actual ETA. The geospatial data includes, but not limited to, bounding box size, point of interest, surrounding dwellings, surrounding vehicles and prediction confidence. The regulatory and compliance data includes, but not limited to, information related to tyres, regulated access zones, energy use and emission reporting of vehicles, wherein the data from vehicle repositories includes national & official vehicle classification, international vehicle classification and original equipment manufacturer (OEM) vehicle information.

The server 102 is further configured to receive image data of the vehicles from an image capturing device. In one embodiment, the image capturing device includes, but not limited to, city cameras and other video/image recording ground devices. In another embodiment, the image capturing device includes satellite and other earth observation cameras (e.g. drones) which can record hyperspectral and/or multispectral images of vehicles and their surroundings. The server 102 is further configured to receive video data of the vehicles from a video recording device. The server 102 is further configured to receive acoustic data and vibration data of the vehicles from the sensors. In one embodiment, the sensors include smart city sensors that record acoustic and other types of vibrations, for example, smart phone sensors, third party sensors, accelerators, audio and vibration sensor, and telematics sensor.

The data cleansing module 208 is configured to cleanse vehicle data based on a level of risk associated with each vehicle data type. The data cleansing module 208 enhances and purifies vehicle (asset) information as a preliminary step in the process. This ensures that the data is accurate, reliable, and optimized for further stages of analysis. The data cleansing module 208 could add a confidence interval at each stage of the data cleaning process. This confidence is key to support the risk estimation process. Essentially risks are also estimated from the combination of two key variables including the probability of something happening (Likelihood) and its impact (Severity). The risk aspect of the process has three levels including high (potentially regulatory/audit problems or greenwashing claims that can damage company reputation), medium and low risk. In an example, conservative values, that do not cause any regulatory or reputational damage but are not optimal-such as lead to high emissions, low tax credits, etc., are used. Probability (Likelihood) of something happening (with the associated confidence levels), combined with the impact scale (Severity) mentioned above provides the final risk matrix for different aspects of the process.

The risk analysis module 210 is further configured to detect one or more issues in the vehicle data and generate a risk matrix. The risk analysis module 210 is further configured to determine the level of risk of each vehicle data. In one embodiment, the risk analysis module 210 is configured to systematically detect issues of varying degrees of severity and confidence within the data. The outcome of this process is a comprehensive risk matrix, aiding users in prioritizing data cleansing activities. The risk matrix generated from the Al/ML analysis becomes a pivotal tool. It assists users in identifying and focusing on data cleansing tasks based on the level of risk associated with each vehicle data.

The output module 212 is configured to determine an official classification of the vehicles and suggest correction of existing assignments of classification of vehicles if the existing assignments are incorrect. The output module 212 along with multi-modal machine learning (ML) algorithms produce accurate prediction of the classification of the vehicles. The server 102 is further configured to utilize data on various vehicle's characteristics, movement patterns and operational details to determine emission values. The server 102 could use programs, AI/ML or other simulation techniques or other default data approaches along with the classification of vehicles to determine the emission value. The server 102 utilizes machine learning models to predict the class using vehicle characteristics other than VIN.

The program modules further include a VIN decoding module, a VIN validation module and a VIN correction module. The VIN decoding module is configured to decode vehicle identification number (VIN) related data 114. The VIN validation module is configured to validate the VIN related data 114. The VIN decoding module and VIN validation module are further configured to determine and decode incorrect VIN related data. The VIN correction module is configured to suggest modification of the VIN related data when determining errors in the VIN related data 114.

The output module 212 along with modules employs machine learning models to predict the classification of vehicles when dealing with no VIN or incorrect or incomplete VINs. The ML-based models are based on Multi-Modal techniques that combine Recurrent Neural Network (RNN) (e.g. Time series data), Convolutional Neural Network (CNN) (e.g. Visual Data) and other ANN (Artificial Neural Network) to deliver the classification of vehicles (e.g. Fusion Modules). The established vehicle class is employed as a corrective measure. When inconsistencies are detected, the system overrides or suggests improvement to existing assignments that are deemed incorrect. Furthermore, the system fills in missing information based on a multifaceted approach involving considerations such as risk assessment, confidence levels, and user-defined criteria.

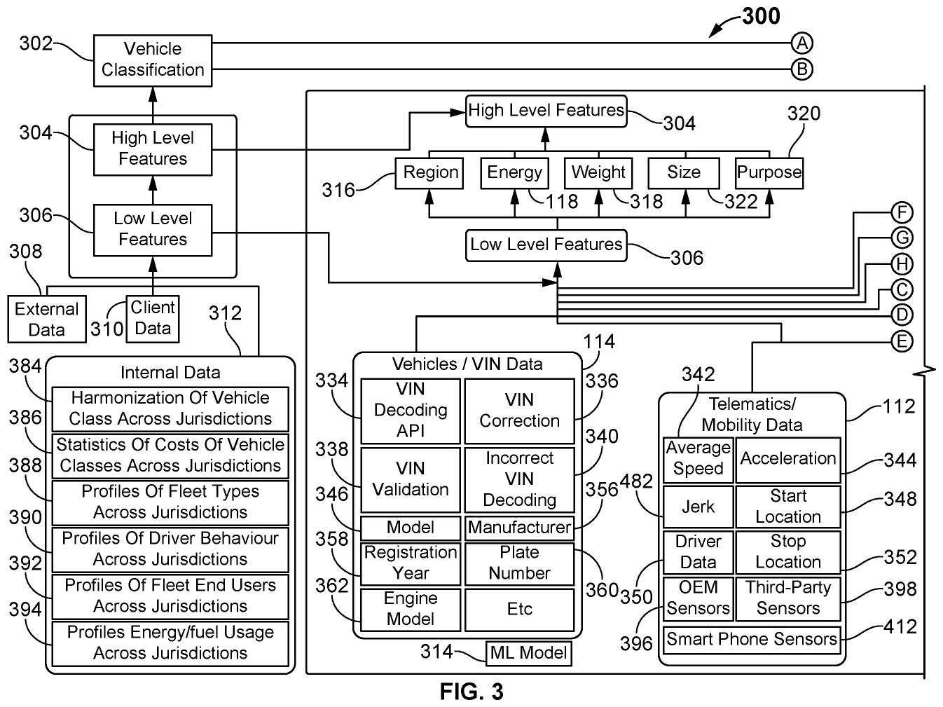

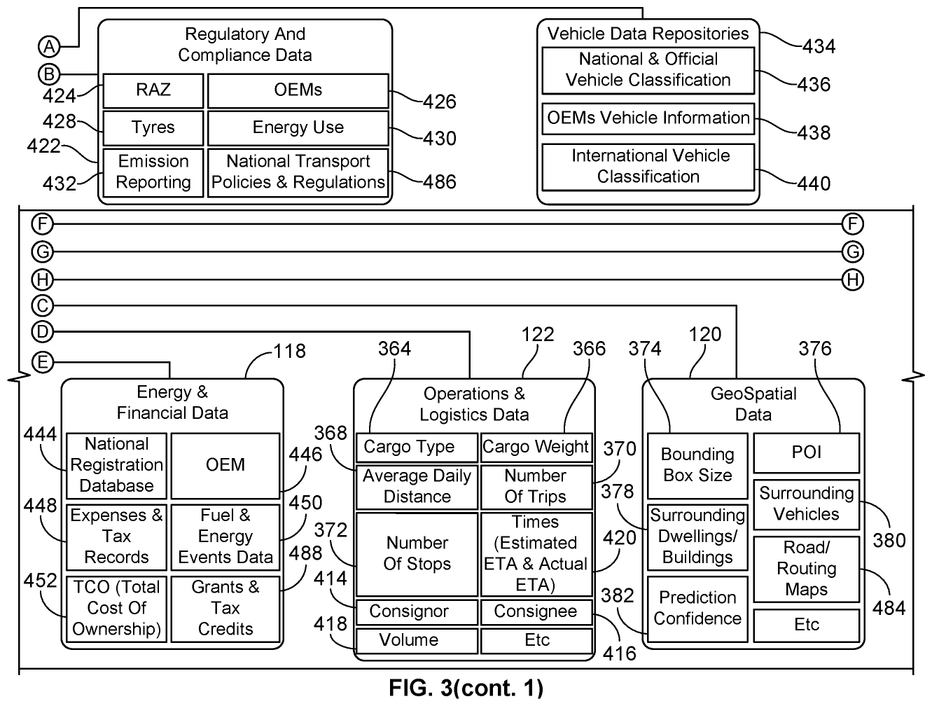

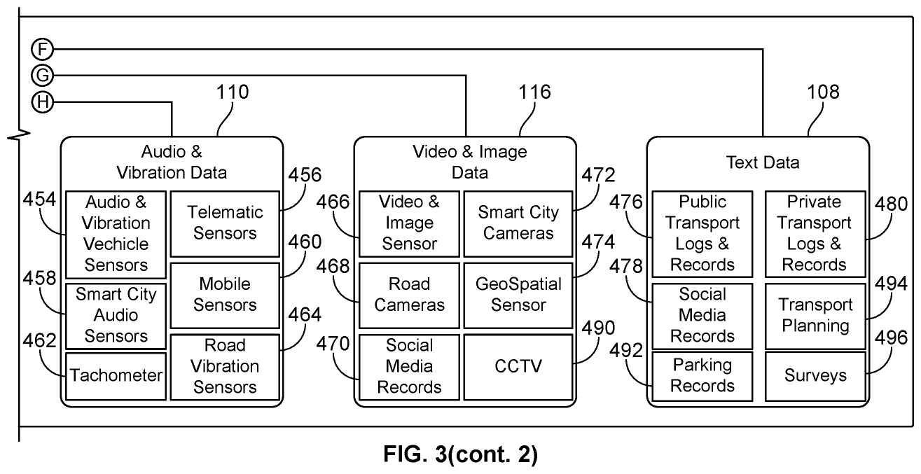

FIG. 3 is a block diagram 300 of different types of vehicle data collected by the system for vehicle classification 302, according to an embodiment of the present invention. The system comprises a series of machine learning (ML) models 314 for determining vehicle classification 302 (including multi-modal MLs). The system is configured to receive external data 308, client data 310 and internal data 312 for vehicle classification 302. The external data 308 includes satellite/geospatial data 120, regulatory & compliance data 422, energy data 118, text data 108, image data 116, audio data 110 and vehicle data 114. The client data VIN data 114, telematics data 112, energy data 118, operations data 122, text data 108, audio data 110 and image data 116. The internal data 312 includes harmonization of vehicle class across jurisdictions 384, statistics of costs (e.g. min, max, mean) of vehicle classes across jurisdictions 386, profiles of fleet types across jurisdictions 388, profiles of driver behavior across jurisdictions 390, profiles of fleet end users across jurisdictions 392, profiles energy/fuel usage across jurisdictions 394, etc. The system of the present invention is configured to receive high level features 304 and the low-level features 306 for vehicle classification 302.

The high-level features 304 include region 316, energy data 118, weight 318, size 322, purpose 320 and of the vehicle. The low-level features 306 includes vehicle identification number (VIN) related data 114, telematics/mobility data 112, vehicle identification details, operations/logistics details 122 of vehicle and satellite/geospatial data 120, and energy and financial data 118.

The system comprises VIN decoding application interface (API) 334 for decoding VIN related data. The system is further configured to provide VIN correction 336, VIN validation 338 and incorrect VIN decoding 340.

The vehicle identification details/VIN data 114 (also referred as the identification data) of the vehicles includes model 346, manufacturer 356, registration year 358, plate number 360, engine model 362, etc. The vehicle identification number (VIN) related data 114 and vehicle identification details are typically stored in “asset management” or “logistics assets” platforms that contain information about the vehicle. The data types explained with respect to FIG. 1 and FIG. 3, are extracted using, for example, via APIs, Secure File Transfer Protocol (SFTP), Direct database Connection, manual File Extracts/Transfers, etc. The details 114 are extracted using all possible/common data transfers mechanisms between organizations.

The telematics/mobility data 112 (also referred as trip data) of the vehicles include average speed 342, acceleration 344, jerk 482, start location 348 of the vehicles, anonymized driver's data 350, stop location 352 of the vehicles, OEM sensors 396, third party sensors 398, smart phone sensors 412, etc. The telematics/mobility data 112 is typically found in telematics, fleet management platforms, tachographs, connected vehicle, apps or other sensor-based systems that can gather GPS, acceleration/deceleration, vibration, sound and other sensor-based data from the vehicle itself or its cargo (for example, from people & goods).

The logistics/operational details 122 (also referred as operation data) of the vehicles includes cargo type 364, cargo weight 366, average daily distance 368, number of trips 370, number of stops 372, consignor 414, consignee 416, volume 418, Times (Estimated ETA, Actual ETA) 420, and volume 418, etc. The operations/logistics details 122 is typically found on procurement, enterprise resource planning (ERP), Transport Management Systems (TMS), business processes or other enterprise business process or operations systems. An example of this type of Software is the well-known SAP. The details 122 are extracted using all possible/common data transfers mechanisms between organizations.

The satellite/geospatial details 120 (also referred as geospatial data) of the vehicles includes bounding box size 374, point of interest (POI) 376, surrounding dwellings/buildings 378, surrounding vehicles 380, prediction confidence 382, road/routing maps 484 etc. The satellite/geospatial data 120 could be found in geospatial programs such as the EU copernicus program. The geospatial programs could also involve “smart city” programs with cameras and other smart city systems that could gather visual/video, audio with geospatial context. The satellite data 120 could be received in any range of the electromagnetic spectrum. The satellite data 120 are extracted using all possible/common data transfers mechanisms between organizations.

The system is further configured to receive regulatory & compliance data 422, which includes for example things that affect: transport such as regulated access zones (RAZ) 424, original equipment manufacturing (OEMs) 426, tyers 428 (e.g. Rolling Resistance), energy use 430, emissions reporting 432, national transport policies and regulations 486, etc. The regulatory and compliance data 422 further includes traffic & congestion control, GHG emissions (CO2, CH4, N2O, etc.), noise, tyre wear, etc. The regulated access zones 424 includes, but not limited to, low emissions zones, zero emission zones, urban road tolls, and many other access regulations.

The system is further configured to receive data from vehicles data repositories 434. The data includes national & official vehicle classification 436 (e.g., NHTSA); OEMs Vehicle Information 438 (e.g., Brand, Model); international vehicle classification 440 (e.g., UNECE), etc.

The system is further configured to receive financial and energy data 118. The financial and energy data 118 includes, but not limited to, national registration database 444, OEM 446, expenses and tax records 448, fuel and energy events data 450, data related to total cost of ownership (TCO) 452, grants & tax credits 488, etc.

The system is further configured to receive audio and vibration data 110 from one or more devices including, but not limited to, audio vibration and vehicle sensors 454, telematic sensors 456, smart city audio sensors 458, mobile sensors 460, tachometer 462 and road vibration sensors 464, etc.

The system is further configured to receive video and image data 116 from one or more devices including, but not limited to, vehicle video and image 466, smart city cameras 472, road cameras 468, geospatial sensor 474. The video and image data 116 further includes, but not limited to, social media records 470, CCTV 490 and many other types of videos and image recording.

The system is further configured to receive text data 108. The text data 108, includes, but not limited to, public transport logs and records 476, social media records 478, private transport logs and records 480, parking records 492, transport planning 494, surveys 496, etc.

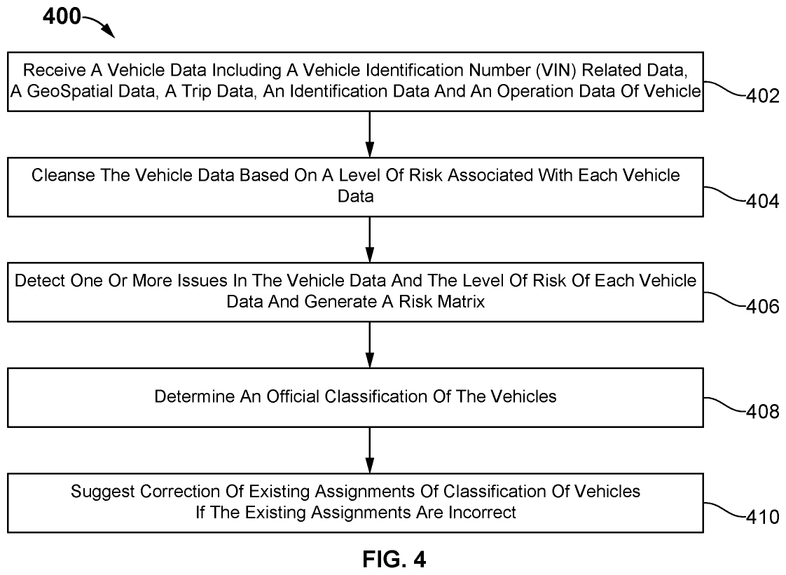

FIG. 4 exemplarily illustrates a flowchart of a method 400 for accurate validation and prediction of official classification of vehicles, according to an embodiment of the present invention. The method 400 is executed at the system comprising at least one database 104 comprising information related to classification of vehicles, and at least one server 102 in communication with the database 104. The server 102 comprises one or more processors 202 and at least one memory 204 storing a set of program modules executable by the processor 202.

The system can further comprise one or more video recording devices in communication with the server 102. The video recording devices are configured to record video data of the vehicle. The server 102 is configured to receive video data and image data of the vehicle. The system further comprises one or more sensors in communication with the server 102. The sensors are configured to receive audio data and vibration data related to the vehicle to the server 102.

At step 402, the input module 206 is configured to receive vehicle data. The vehicle data includes at least one of a vehicle identification number (VIN) related data, a geospatial data, a trip or a route data, an identification data and an operation data of the vehicle. The input module 206 is configured to receive vehicle data from any data sources/modes. The vehicle data can further include image data, video data, audio data, vibration data, region, weight, purpose and size of vehicle, etc. The trip data of the vehicle can include average speed, jerk, vibration, sound, driver's behavior, acceleration, start location of the vehicle and stop location of the vehicle. The identification data of the vehicle can include model, registration year, engine model, manufacturer and plate number. The operation data of the vehicle can include cargo type, average daily distance, number of stops, cargo weight, number of trips, consignor, consignee, volume and time including estimated, expected time of arrival (ETA) and actual ETA. The geospatial data of the vehicle can include bounding box size, point of interest, surrounding dwellings, surrounding vehicles and prediction confidence.

At step 404, the data cleansing module 210 is configured to cleanse vehicle data based on the level of risk associated with each vehicle related data.

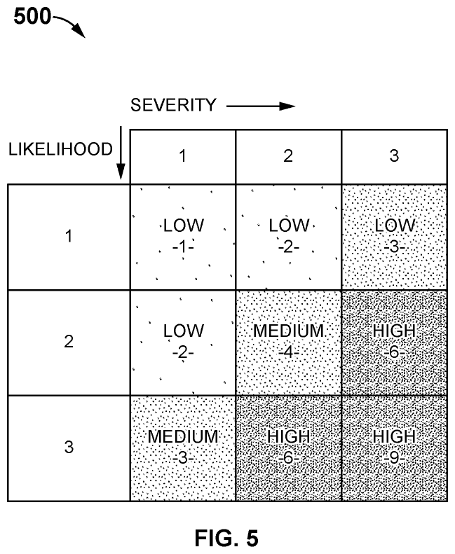

At step 406, the risk analysis module 208 is configured to detect one or more issues in the vehicle data and generate a risk matrix. The risk analysis module 208 is further configured to determine a level of risk of each vehicle data. The levels include at least three level ranges, as shown in table 500 of FIG. 5.

At step 408, the output module 212 is configured to determine an official classification of the vehicles.

At step 410, the output module 212 is configured to suggest correction of existing assignments of classification of vehicles if the existing assignments are incorrect.

Further, if the vehicle data comprises vehicle identification number (VIN) related data, the VIN decoding module is configured to decode vehicle identification number (VIN) related data, the VIN validation module is configured to validate the VIN related data, and the VIN correction module is configured to suggest modification of the VIN related data when determining errors in the VIN related data. The server 102 is further configured to determine default emission values of the vehicle.

FIG. 5 exemplarily illustrates a table 500 for assessing different levels of risk of vehicle data, according to an embodiment of the present invention. The severity is determined from the impact of misrepresenting a dataset such as fines, omission cost, reputation etc., This dimension is generic and therefore the same across most organizations in the same jurisdiction (although tailoring to specific organization priorities is possible). The likelihood is determined from the datasets ingested. This dimension can be very specific to an organization and jurisdiction.

Advantageously, the system and method effectively validate and/or predict a vehicle's official classification by utilizing various vehicle's characteristics and operational conditions from internal and/or external databases. The system validates and predicts the official vehicle's classification using a variety of vehicle's characteristics, movement patterns and operational details. The system enables to optimize fleet management and emission compliance through accurate vehicle classification. The system enhances fleet asset management by offering a streamlined approach to auditing fleet inventory.

The system further enables emissions reporting and compliance. In the pursuit of sustainable transportation practices, adhering to emission standards is of paramount importance. The present invention facilitates emissions reporting by ensuring that each vehicle's official classification is correctly established based on its characteristics and operations. This precision enhances compliance with emission regulations tailored to specific vehicle classes, subsequently contributing to reduced environmental impact and fostering a cleaner urban environment.

The system further facilitates fleet modernization and decarbonization. By leveraging the system's comprehensive classification approach, fleet managers gain clarity into their fleet's composition and distribution across different classes. This insight guides strategic decisions, enabling operators to prioritize the replacement of high-emission vehicles with environmentally friendly alternatives, thereby advancing the overall decarbonization agenda. Further, the comprehensive vehicle classification could be leveraged in market brokerage systems such as carrier/shipping (e.g., Uber Freight). Further, new business opportunities could be suggested for the right vehicle classification that operates under the right conditions (e.g., route).

The system further enables to make informed policy decisions within the sustainable transportation sphere. Policymakers could harness the accurate classification of vehicles to craft regulations and incentives tailored to specific classes. This informed approach ensures that policies are effective, targeted, and aligned with overarching sustainability goals.

The system further enables to make data-driven decision for fleet operators. The system establishes a comprehensive framework for accurately classifying and managing vehicle data, ensuring integrity, and enhancing decision-making processes. The system further supports operational changes that improve energy/fuel efficiency, accurate profiling of the vehicle classification is essential. Profiling outcomes could enable sustainability improvements across the entire fleet or specific vehicle classifications.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for accurate validation and prediction of classification of vehicles, comprising:
at least one database comprising information related to official classification of vehicles, and
at least one server in communication with the database, wherein the server comprises one or more processors and at least one memory storing a set of program modules executable by the processor, wherein the server comprises an artificial intelligence and machine learning model, wherein the program modules comprise:
an input module configured to receive vehicle data, wherein the vehicle data includes at least one of a vehicle identification number (VIN) related data, a geospatial data, a trip data, an identification data and an operation data of vehicle;
a data cleansing module configured to cleanse vehicle data based on a level of risk associated with each vehicle data;
a risk analysis module configured to detect one or more issues in the vehicle data and generate a risk matrix, wherein the risk analysis module is further configured to determine the level of risk of each vehicle data, and
an output module configured to determine an official classification of the vehicles and suggest correction of existing assignments of classification of vehicles if the existing assignments are incorrect.

2. The system of claim 1, wherein the program modules further comprise:
a VIN decoding module configured to decode vehicle identification number (VIN) related data;
a VIN validation module configured to validate the VIN related data, and
a VIN correction module configured to suggest modification of the VIN related data when determining errors in the VIN related data.

3. The system of claim 1, wherein the server is further configured to determine emission values of the vehicle using vehicle data and classification of vehicle.

4. The system of claim 1, wherein the vehicle data further includes video and image data, audio and vibration data, regulatory and compliance data, operations and logistics data, energy data, financial data, telematics and mobility data, data from vehicle repositories, text data, and internal data.

5. The system of claim 1, wherein the vehicle data further includes region, weight, purpose and size of vehicle.

6. The system of claim 1, wherein the regulatory and compliance data includes information related to tyres, regulated access zones, energy use and emission reporting of vehicles, wherein the data from vehicle repositories includes national and official vehicle classification, international vehicle classification and original equipment manufacturer (OEM) vehicle information.

7. The system of claim 1, wherein the trip data of the vehicle includes average speed, jerk, vibration, sound, driver's behavior, acceleration, start location of the vehicle and stop location of the vehicle.

8. The system of claim 1, wherein the identification data of the vehicle includes model, registration year, engine model, manufacturer and plate number.

9. The system of claim 1, wherein the operation data of the vehicle includes cargo type, average daily distance, number of stops, cargo weight, number of trips, consignor, consignee, volume and time including estimated, expected time of arrival (ETA) and actual ETA.

10. The system of claim 1, wherein the geospatial data of the vehicle includes bounding box size, point of interest, surrounding dwellings, surrounding vehicles and prediction confidence.

11. The system of claim 1, further comprises one or more sensors in communication with the server, wherein the sensors are configured to receive and send audio data and vibration data related to the vehicle to the server, wherein the sensors comprise OEM sensors, smart phone sensors, third party sensors, audio and vibration sensors and telematics sensors.

12. A method for accurate validation and prediction of classification of vehicles, comprising the steps of:
providing at least one database comprising information related to official classification of vehicles, and at least one server in communication with the database, wherein the server comprises one or more processors and at least one memory storing a set of program modules executable by the processor, wherein the server comprises an artificial intelligence and machine learning model;
receiving, at the server via an input module, vehicle data, wherein the vehicle data includes at least one of a vehicle identification number (VIN) related data, a geospatial data, a trip data, an identification data and an operation data of vehicle;
cleansing, at the server via a data cleansing module, vehicle data based on a level of risk associated with each vehicle data;
detecting, at the server via a risk analysis module, one or more issues in the vehicle data and the level of risk of each vehicle data, and generating a risk matrix;
determining, at the server via an output module, an official classification of the vehicles, and
suggesting, at the server via the output module, correction of existing assignments of classification of vehicles if the existing assignments are incorrect.

13. The method of claim 12, wherein the vehicle data comprises vehicle identification number (VIN) related data, the method further comprising the step of:
decoding, at the server via a VIN decoding module, decode vehicle identification number related data;
validating, at the server via a VIN validation module, the VIN related data, and
suggesting, at the server via a VIN correction module, modification of the VIN related data when determining errors in the VIN related data.

14. The method of claim 12, further comprising the step of: determining, at the server, default emission values of the vehicle using vehicle data and classification of vehicle.

15. The method of claim 12, wherein the vehicle data further includes video and image data, audio and vibration data, regulatory and compliance data, operations and logistics data, energy data, financial data, telematics and mobility data, data from vehicle repositories, internal data, text data, and region, weight, purpose and size of vehicle, and wherein the trip data of the vehicle includes average speed, jerk, vibration, sound, driver's behavior, acceleration, start location of the vehicle and stop location of the vehicle.
